(19) United States
(12) Patent Application Publication
(10) Pub. No.: US 2006/0225414 A1
(43) Pub. Date: Oct. 12, 2006

(54) Pneumatic generator cycle system

(76) Inventor: Yu-Chuan Fan, Longtan Township (TW)

Correspondence Address: RABIN & Berdo, PC, 1101 14TH STREET, NW, SUITE 500, WASHINGTON, DC, 20005, US

(21) Appl. No.: 11/103,455

(22) Filed: Apr. 12, 2005

(51) Int. Cl. F16D 31/02

(52) U.S. Cl. 60/407

(57) ABSTRACT

A pneumatic generator cycle system includes a table, a plurality of cylinders, a carried, and a pneumatic generator. The cylinders exhaust air from the air outlet of the cylinders by weight of the carrier and the carried object, and cause the tablet to slope towards location of the carried object when the moving carried moves to the location of one of the cylinders. Simultaneously, pneumatic generator generates electricity via importing air to the air inlet of the pneumatic generator, and air flow through the outlet of the generator to the inlet of the cylinder, finally back to the cylinder exhausted the air before. The tablet is restored to balanced status due to previous process, and the tablet is raised to keep the carrier moving to the next cylinder.

### BACKGROUND OF THE INVENTION

1. Field of the Invention

The present invention relates generally to a power generator system, and in particular to a pneumatic generator cycle system.

2. The Related Art

Because fossil energy that the civilization of human beings relies on heavily will be exhausted in the near future, people are uninterruptedly searching new energy source for replacing oil. For instance, the solution used for replacing oil could be hydroelectricity, electricity from burning, wind power, tidal force, biomass energy, geothermal power, and solar energy, or efficiency increasing via the use of fuel cell or cogeneration technology.

However, the gas produced from burning is several hundredfold comparing with hydroelectricity, but hydroelectricity may lead to the damage of nature environment. Since use of wind power exits limitations related to season and time, it is neither a stable nor a reliable electricity producing method. As to tidal force, probably cause another influence to coastal environment. Pollutions come from manufacture process of solar power panel, and acquirement for biomass energy needs vast land. Therefore, except the previous methods, there is necessary to find another way for electricity generating.

### SUMMARY OF THE INVENTION

An object of the present invention is to provide a pneumatic generator cycle system, wherein the pneumatic generator generates electricity by air recycling between the cylinders due to movement of the carrier and a heavy object carried by the carrier, and the carried object is moved continuously by force from the raising tablet to keep the operation of the pneumatic generator constantly.

The present invention relates generally to a pneumatic generator cycle system, comprising a table, a plurality of cylinders, a carrier, and a pneumatic generator. The plurality of cylinders, having one-directional air inlet and air outlet, is placed under the tablet uniformly to support the tablet. The pneumatic generator has one-directional air inlet air and air outlet, wherein the air inlet of pneumatic generator is connected with the air outlet of the cylinders, and the air outlet of pneumatic generator is connected with the air inlet of the cylinders.

The cylinders discharge air from the air outlet of the cylinders when the moving carrier moves to one of the cylinders, and causing the tablet sloping towards the location of the carrier. Simultaneously, the pneumatic generator generates electricity via importing air to the air inlet of the pneumatic generator, and air flow from the outlet of the generator through the inlet of the cylinder, back to the cylinder exhausted air before. The tablet is restored to balanced status due to previous process, and the tablet is raised to keep the carrier moving to the next cylinder.

### BRIEF DESCRIPTION OF THE DRAWINGS

The present invention will be apparent to those skilled in the art by reading the following description of preferred embodiments thereof, with reference to the attached drawings, in which:

FIGS. 1A-1C are diagrams showing a pneumatic generator cycle system according to the present invention.

FIG. 2 is another diagram showing the pneumatic generator cycle system according to the present invention.

FIGS. 3A-3C are operating diagrams showing the pneumatic generator cycle system according to the present invention.

### DETAILED DESCRIPTION OF THE PREFERRED EMBODIMENTS

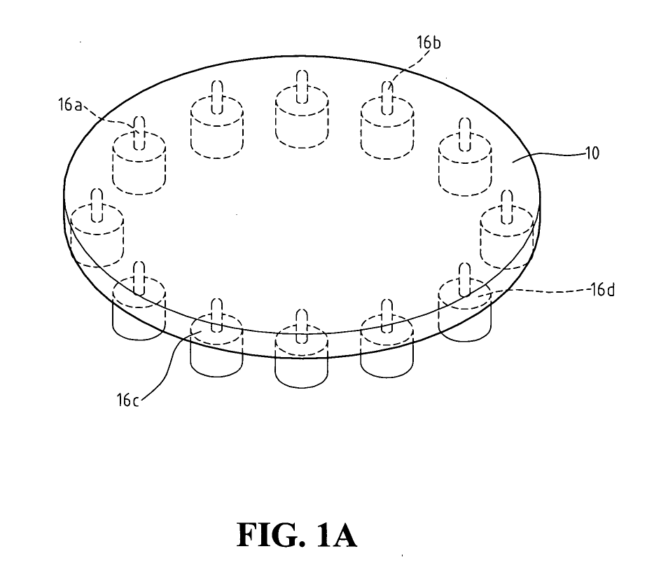

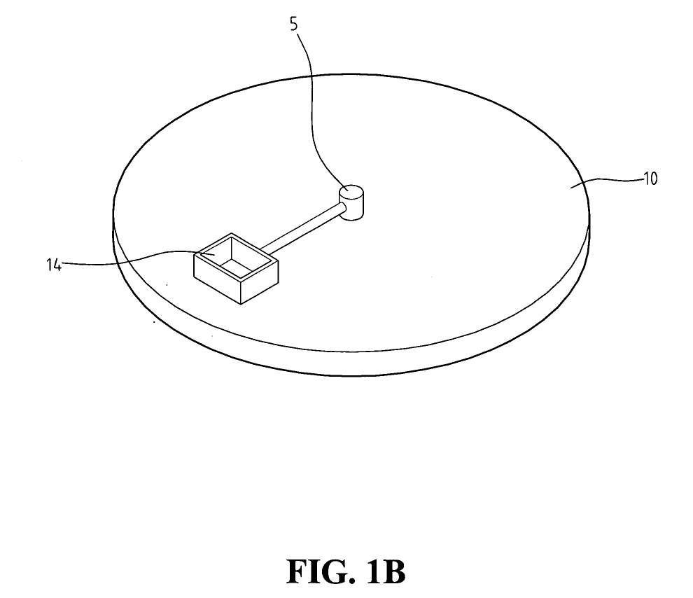

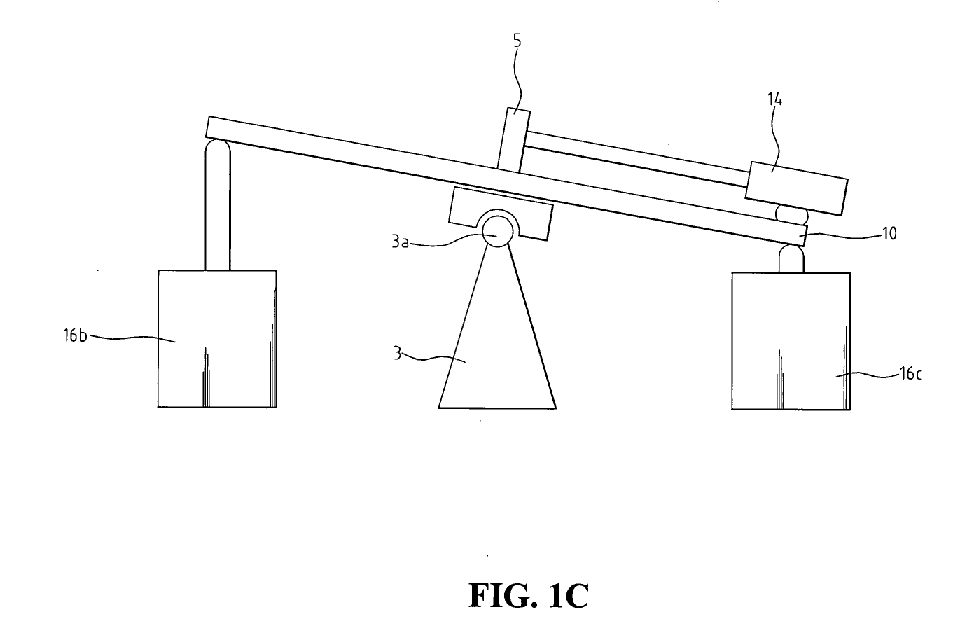

Referring to FIGS. 1A and 1B of the attached drawings, a pneumatic generator cycle system according to the present invention comprises a tablet 10 which have a pillar 5 arranged above the tablet 10 and a plurality of cylinders (at least twelve cylinders) arranged under the tablet 10 to sustain and selectively raise the tablet 10. A carrier 14 is movably positioned on the tablet 10 and is coupled to the pillar 5. The carrier 14 is allowed to move around the pillar 5 and keeping a certain distance from the pillar 5. The carrier 14 carries a weight, such as a heavy object, which makes the system operating sufficiently. A central portion of the tablet 10 is held by a spherical portion 3a of a brace 3, whereby the tablet slopes along with movement of the carrier 14 due to lower frictional force based on the link between the spherical portion 3a and the tablet 10.

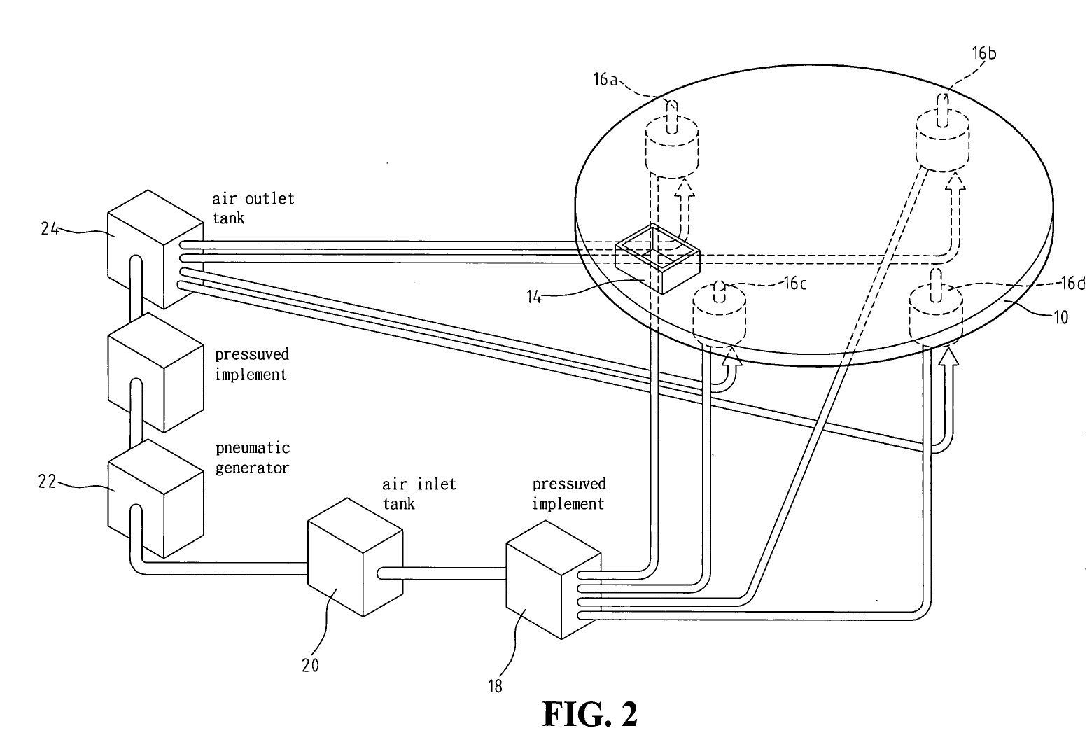

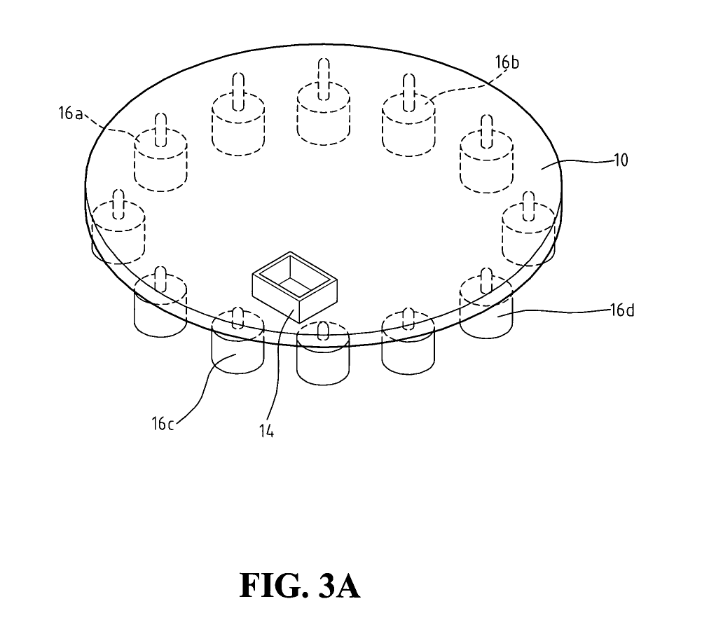

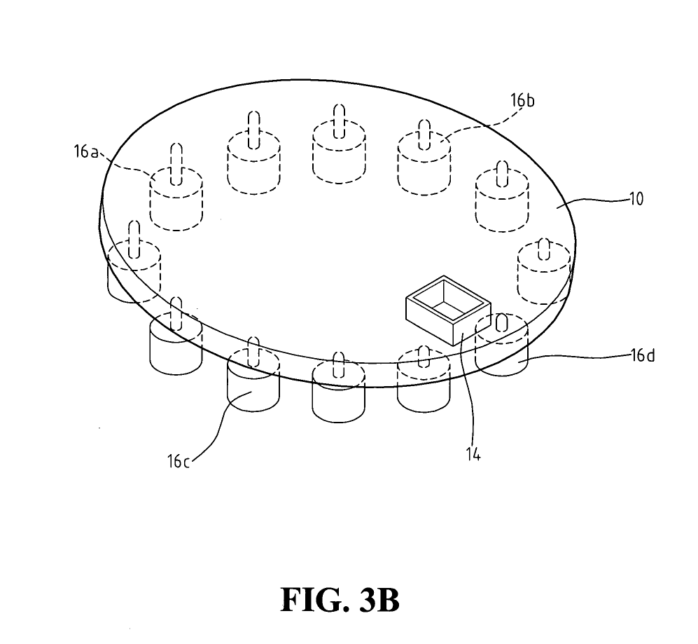

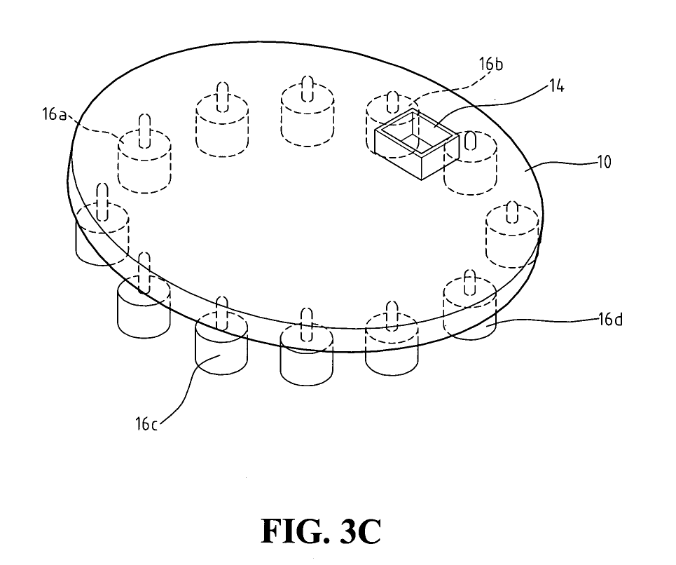

FIG. 2 is another diagram showing the pneumatic generator cycle system according to the above preferred embodiment of the present. Referring to FIGS. 3A-3C of the attached drawings, showing another diagram of the pneumatic generator cycle system according to the present invention, the pneumatic generator cycle system comprises a tablet 10, a plurality of cylinders (only cylinders 16a-6d being shown for simplification), a carrier 14, and a pneumatic generator 22, as for a plurality of pressured implements 18 and 23, air inlet tank 20, air outlet tank 24 being used to increase efficiency of the system but not necessary for the system. The cylinders 16a-16d are placed uniformly under the approximate four corners of the tablet 10.

The cylinders 16a-16d comprise an implement used to rise and descend the tablet 10 with the pressure variation so as to raise the tablet 10 dynamically with the pressure variation in the cylinders. In other words, if the pressure within the cylinder 16a decreases, the tablet 10 slopes towards the cylinder 16a, and the portion of the tablet 10 associated with the cylinder 16d opposite to the cylinder 16a is the highest part of the tablet 10. On the contrary, the tablet 10 is raised towards location of the cylinder 16a if the pressure within the cylinder 16a increases.

Due to the connection between the tablet 10 and the plurality of cylinders 16a-16d, if the pressure within the cylinder 16c illustrated on FIG. 3A is decreased at first, the tablet 10 is raised towards the location of the cylinder 16c and makes the carrier 14 moving to the cylinder 16d. The cylinder 16d, above which the carrier 14 is currently located, is depressed by the weight of the carrier 14, thereby refilling air in the cylinder 16d to force the carrier 14 moves to the next cylinder 16b. The carrier 14 moves around the surrounding portion of tablet 10. Therefore, the emphasis of present invention is how to exhaust and refill the air in the cylinders following the sequence (cycle) of the cylinders by 16c, 16d, 16b, 16a, and 16c, and make the cylinders 16a-16d having enough and continuous difference of pressure to maintain the operation of the pneumatic generator in order to generate electricity.

Therefore, in simplification, the pneumatic generator cycle system of the present invention refill the cylinders which have exhausted air or decreased air pressure previously by recycling and utilizing the air from the air outlet of the pneumatic generator 22, so as to exhaust and refill the air in the cylinders following the sequence (cycle) of the cylinders: 16a, 16b, 16c, 16d, and 16a, and keep the carrier 14 moving on the tablet 10 continuously. That means the carrier 14 moves by the sequence (cycle) of the cylinders: 16a, 16b, 16c, 16d, and 16a to force the cylinders exhausting air to the generator 22 with the sequence (cycle) of the cylinders: 16a, 16b, 16c, 16d, and 16a to generate electricity by pushing the generator 22 continuously.

Referring to FIGS. 3A-3C of the attached drawings, when the location of the carrier 14 illustrated in the FIG. 3A is moved to the location illustrated in the FIG. 3B by rising the cylinders, the cylinder 16d has exhausted air gradually due to weight of the carrier 14 before the carrier 14 completely reaching the location of the cylinder 16c, and import air to the air inlet of the generator 22 through the high-pressure pipe line to push the generator 22. However, although the cylinders 16a-6b exhaust air one by one due to weight of the carrier 14, the outlet of the cylinders 16a-16b have kind of capability to against gravity and the outlet of the cylinders is one-directional. Said situation cause air or air pressure in the cylinders 16a and 16b cannot be exhausted completely.

Therefore, the cylinder 16d raises the tablet 10 on the location of the cylinder 16d when air exhausted by generator 22 after generating electricity is imported through the outlet of the generator 22 to the inlet of the cylinder 16d, thus the carrier 14 moves to the location illustrated in FIG. 3.

In order to increase efficiency of the pneumatic generator for electricity generating, the pneumatic generator cycle system of the present invention further comprises an air inlet tank 20 and a pressured implement 18. The air inlet tank 20 used to temporarily save air exhausted from the air outlet of the cylinders 16a-16d and exhaust air to the air inlet of the generator 22. The pressured implement 18, placed between the cylinders 16a-16d, pressurized air exhausted by one of the cylinders 16a-16d then import air to the air inlet tank 20. As a result, the implement 18 can recover air or air pressure loss caused by electricity generating process of the generator 22 or transmitting between pipeline and device, and make sure working of the generator system continuous.

At last, amount of electricity generating by the generator 22 can be improved by increasing the number of the cylinders to provide air pressure or air that can support the generator 22 to operate continuously. However, the plurality of cylinders should at least comprise twelve cylinders. The cylinders, used to move the carrier 14 around the pillar 5 on the tablet 10, are placed under the tablet 10 symmetrically.

One skilled in the art will understand that the embodiment of the present invention as shown in the drawings and described above is exemplary only and not intended to be limiting. It will thus be seen that the objects of the present invention have been fully and effectively accomplished. Its embodiments have been shown and described for the purposes of illustrating the functional and structural principles of the present invention and is subject to change without departure form such principles. Therefore, this invention includes all modifications encompassed within the spirit and scope of the following claims.

What is claimed is:

1. A pneumatic generator cycle system, comprising:
a tablet, having a pillar set on the tablet;
a plurality of cylinders, placed uniformly under the tablet to sustain the tablet and having an one-directional air inlet and an one-directional air outlet;
a carrier, placed on the tablet, connecting with the pillar; and
a pneumatic generator, having an one-directional air inlet and an one-directional air outlet, wherein the air inlet connecting with the outlet of the cylinders and the air outlet connecting with the inlet of the cylinders,
wherein the cylinders exhaust air from the air outlet of the cylinders by weight of the carrier and the carried object, and cause the tablet sloping towards location of the carried object when the moving carried object moves to the location of one of the cylinders, and wherein simultaneously, pneumatic generator generate electricity via importing air to the air inlet of the pneumatic generator, and air flow through the outlet of the generator to the inlet of the cylinder, finally back to the cylinder exhausted the air before, wherein the tablet is restored to balanced status due to previous process, and the tablet is raised to keep the carrier moving to the next cylinder.

2. The pneumatic generator cycle system as claimed in claim 1 further comprising:
an air inlet tank, used to temporarily save air exhausted from the air outlet of the cylinders and import air to the air inlet of the generator.

3. The pneumatic generator cycle system as claimed in claim 1 further comprising: an air outlet tank, used to temporarily save air exhausted from the air outlet of the generator and import air to the air inlet of the cylinders.

4. The pneumatic generator cycle system as claimed in claim 2 further comprising:
a pressured implement, placed between the cylinders and the air inlet tank, pressuring air exhausted by one of the cylinders and importing to the air inlet tank.

5. The pneumatic generator cycle system as claimed in claim 3 further comprising:
a pressured implement, placed between the pneumatic generator and the air outlet tank, pressuring air exhausted by one of the cylinders and importing to the air outlet tank.

6. The pneumatic generator cycle system as claimed in claim 1, wherein the plurality of cylinders comprises twelve cylinders, and the cylinders placed under the tablet symmetrically.
